(19) United States
(12) Patent Application Publication
(10) Pub. No.: US 2004/0015669 A1
(43) Pub. Date: Jan. 22, 2004

(54) Method, system, and apparatus for an efficient cache to support multiple configurations

(76) Inventors: Samantha J. Edirisooriya, Tempe, AZ (US); Sujat Jamil, Chandler, AZ (US); David E. Miner, Chandler, AZ (US); R. Frank O'Bleness, Tempe, AZ (US); Steven J. Tu, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/199,580

(22) Filed: Jul. 19, 2002

(51) Int. Cl. G06F 12/00; G06F 12/12

(52) U.S. Cl. 711/163; 711/136; 711/144

(57) ABSTRACT

The invention supports a replacement scheme for a cache that supports multiple configurations.

### BACKGROUND

The present disclosure is related to cache memory, such as for cache memory that supports multiple configurations.

As is well-known, a cache stores information for a computer or computing system in order to decrease data retrieval times for a processor. Some examples of computing systems are a personal digital assistant, internet tablet, and a cellular phone. The cache stores specific subsets of information in high-speed memory. A few examples of information are instructions, addresses, and data. When a processor requests a piece of information, the system checks the cache first to see if the information is stored within the cache. If so, the processor can retrieve the information much faster than if the data was stored in other computer readable media, such as, random access memory, a hard drive, compact disc read-only memory (CD ROM), or a floppy disk.

Cache memories have a range of different architectures with respect to addresses locations mapped to predetermined cache locations. For example, cache memories may be direct mapped or fully associative. Alternatively, another cache memory is a set associative cache, which is a compromise between a direct mapped cache and fully associative cache. In a direct mapped cache, there is one address location in each set. Conversely, a fully associative cache that is N-way associative has a total number of N blocks in the cache. Finally, a set associative cache, commonly referred to as N-way set associative, divides the cache into a plurality of N ways wherein each address is searched associatively for a tag.

Typically, integrated devices and/or Systems on a Chip (SoC) utilize embedded memory, such as, cache memory, to store the previously described information. The embedded memory may be utilized in a variety of different applications and allow for multiple configurations. For example, a cache that supports a lock mode offers the advantage of a predictable access latency. A cache that supports a Data RAM (Random Access Memory) configuration allows for direct access without requiring backing memory. The cache may also support both a Data RAM configuration and a lock mode configuration. Also, a portion of the cache may support the lock mode, while the remaining portion does not support the lock mode, resulting in a partially locked cache.

Efficient cache operation utilizes cache management techniques for replacing cache locations in the event of a cache miss. In a typical cache miss, the address and data fetched from the system or main memory is stored in cache memory. However, the cache needs to determine which cache location is to be replaced by the new address and data from system memory. One technique for replacing cache locations is implementing a protocol with least recently used (LRU) bits. Least recently used bits are stored for each cache location and are updated when the cache location is accessed or replaced. Valid bits determine the coherency status of the respective cache location. Therefore, based on the value of the least recently used bits and the valid bits, the cache effectively replaces the cache locations where the least recently used bits indicate the line is the least recently used or the line is not valid. There is a variety of replacement protocols utilized by cache memory, such as, pseudo-LRU, random, and not recently used (NRU) protocols.

If a cache memory supports different modes and configurations, a cache memory designer struggles with the selection of a replacement protocol. For example, if a portion of a cache memory supports the lock mode, a partially locked cache, or supports the Data RAM configuration, it is not available for replacement. Thus, the cache designer struggles with reducing the cache memory design complexity to support multiple modes and configurations while maintaining the existing replacement protocol chosen for the cache memory. One typical solution is for the cache to switch between replacement protocols to support the multiple configurations. However, this increases the complexity of the cache development process and requires more design complexity, testing, validation, and cost.

### BRIEF DESCRIPTION OF THE DRAWINGS

Claimed subject matter is particularly and distinctly pointed out in the concluding portion of the specification. The claimed subject matter, however, both as to organization and method of operation, together with objects, features, and advantages thereof, may best be understood by reference to the following detailed description when read with the accompanying drawings in which:

FIG. 1 is a method utilized by an embodiment.

FIG. 2 is a schematic diagram of a cache utilized by an embodiment.

FIG. 3 is a schematic diagram of a cache utilized by an embodiment.

FIG. 4 is a method utilized by an embodiment.

FIG. 5 is a method utilized by an embodiment.

FIG. 6 is a schematic diagram of a cache utilized by an embodiment.

FIG. 7 is a method utilized by an embodiment.

FIG. 8 is a system utilized by an embodiment.

FIG. 9 is a method utilized by an embodiment.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail so as not to obscure the claimed subject matter.

An area of current technological development relates to supporting multiple configurations of a cache memory. As previously described, cache memories that support multiple configurations require different or complex replacement protocols to support the multiple configurations. Likewise, the prior art cache architectures and replacement protocols do not efficiently support cache memory with multiple configurations. In contrast, an efficient cache memory that supports multiple configurations and utilizes a single efficient replacement protocol will minimize cache development complexity. Likewise, the claimed subject matter allows a cache to maintain the same cache line replacement protocol despite a portion of the cache memory configured to support a Data Ram mode and locking a portion of the cache to support a lock mode.

In one aspect, the claimed subject matter is a replacement scheme and method of adding a lock bit for each line in a cache that supports a lock per line mode for at least one way of the cache. In another aspect, the claimed subject matter is a replacement scheme and method of adding a lock bit for each way in a cache that supports a lock per way mode for at least one way of the cache. In yet another aspect, the claimed subject matter is a replacement scheme and method for a cache memory that supports a Data RAM configuration on a per way basis for at least one way. In another embodiment, the claimed subject matter supports a cache with multiple configurations to allow for a replacement scheme and method. For example in a four way cache, a single way, way 0, of the cache may be locked, and the remaining three ways are unlocked, and the claimed subject matter supports a replacement scheme and method to support the different configurations per way (or per line). In this paragraph, cache may refer to a level 0 (L0), level 1 (LI), and level 2 (L2) caches. However, the claimed subject matter is not limited to L0, L1, or L2 since one skilled in the art appreciates utilizing the claimed subject matter for any level cache.

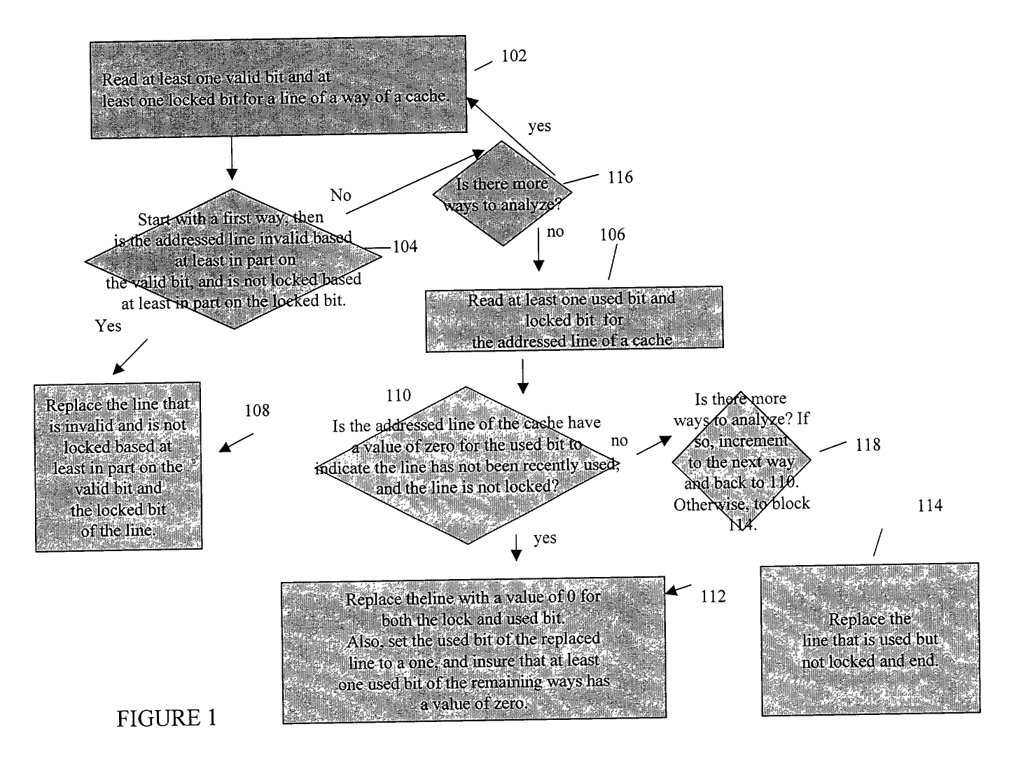

FIG. 1 illustrates a method utilized by an embodiment. The method includes, but is not limited to, the following blocks 102, 104, 106, 108, 110, 112, 114, 116, and 118. In one embodiment, the method supports a replacement scheme for a cache with at least one way, but not necessarily all the ways, that support(s) a configuration of a lock per line mode of the cache. In one example, the cache memory is configured with a lock per line mode for every way of the cache. In another example, the cache memory is configured to have at least one way support the lock per line mode and the remaining ways not support a lock per line mode.

In one embodiment, the cache has a plurality of ways with each way having a plurality of lines. In the same embodiment, at least one way, but not necessarily all the ways, is configured to have a valid bit, used bit, and lock bit for each line of the designated way. In one embodiment, the used bit conforms to a Not Recently Used (NRU) replacement policy. The valid bit determines whether the line has valid or invalid information. For example, the information may be invalid since it is outdated and has been recently replaced in main memory or in another cache. The block 102 reads at least one valid bit and at least one lock bit for a line of a way of a cache. However, for a way or ways that do not support a lock per line mode, it is obvious there will be no lock bit to read. Proceeding to block 104, the method starts by reading at least one valid bit and at least one lock bit for a line of way 0 of a cache. However, the claimed subject matter is not limited to starting with way 0 since in other embodiments, the order of reading the valid and lock bit starts with way 1 or way 2, etc. Alternatively, the method supports reading all the ways in parallel rather than in a sequential manner. The block 104 determines whether the addressed line is invalid and not locked based at least in part on the valid bit and lock bit of the line. If so, the method proceeds to block 108 and replaces the addressed line with the pending new information from the main memory or a different cache.

However, if block 104 is unsuccessful, the method proceeds to block 116 to determine if there are remaining ways to analyze. If so, the method proceeds back to block 102 and repeats the analysis for the next way. Otherwise, the block proceeds to block 106 to read at least one used bit and at least one lock bit for a line of a way of the cache.

Proceeding on to block 110, which tries to identify a line that is not used and is not locked. In one embodiment, the used bit is set to a logic 0 to indicate it has not been recently used and the lock bit is to set to a logic 0 to indicate the line is not locked. If block 110 has a yes result which is the identification of a line that is not used and not locked, then the flow continue to block 112 which allows the cache to replace this line with the pending new information and sets the used bit of the recently replaced line to a value of logic 1 and insures that at least one used bit of the remaining ways has a value of zero. In contrast, if block 110 has a negative result, which is the failure to identify a line that is not used and not locked, then the flow proceeds to block 118. If there are more ways to analyze, block 118 increments to the next way and proceeds back to block 110. Otherwise, the flowchart proceeds and ends at block 114 by replacing the addressed line that is used but not locked.

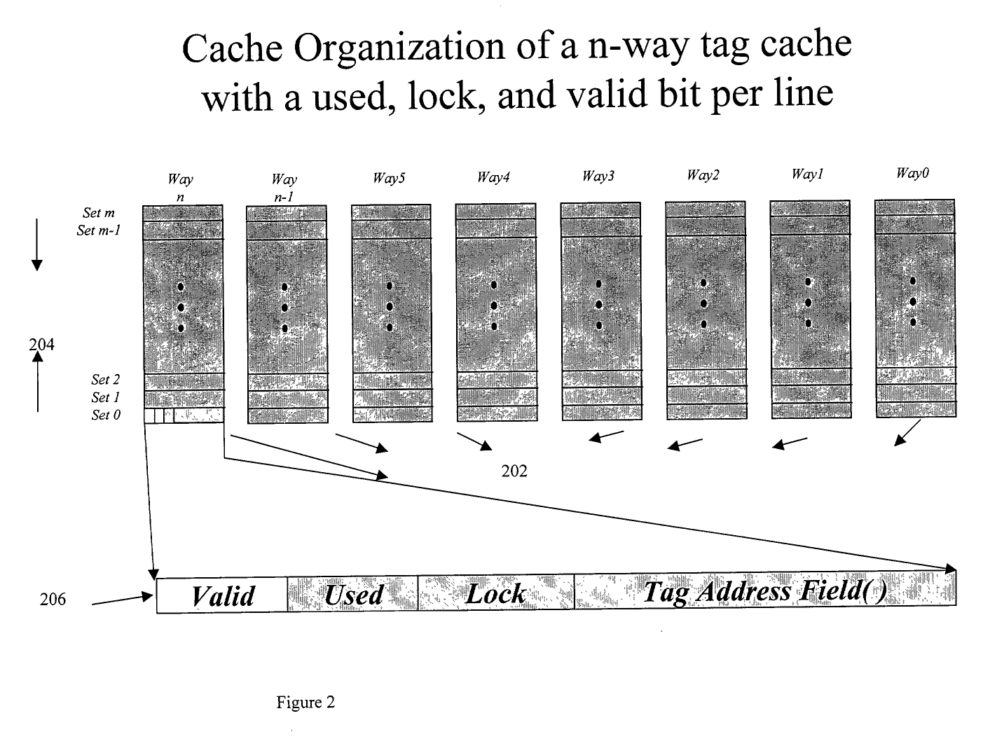

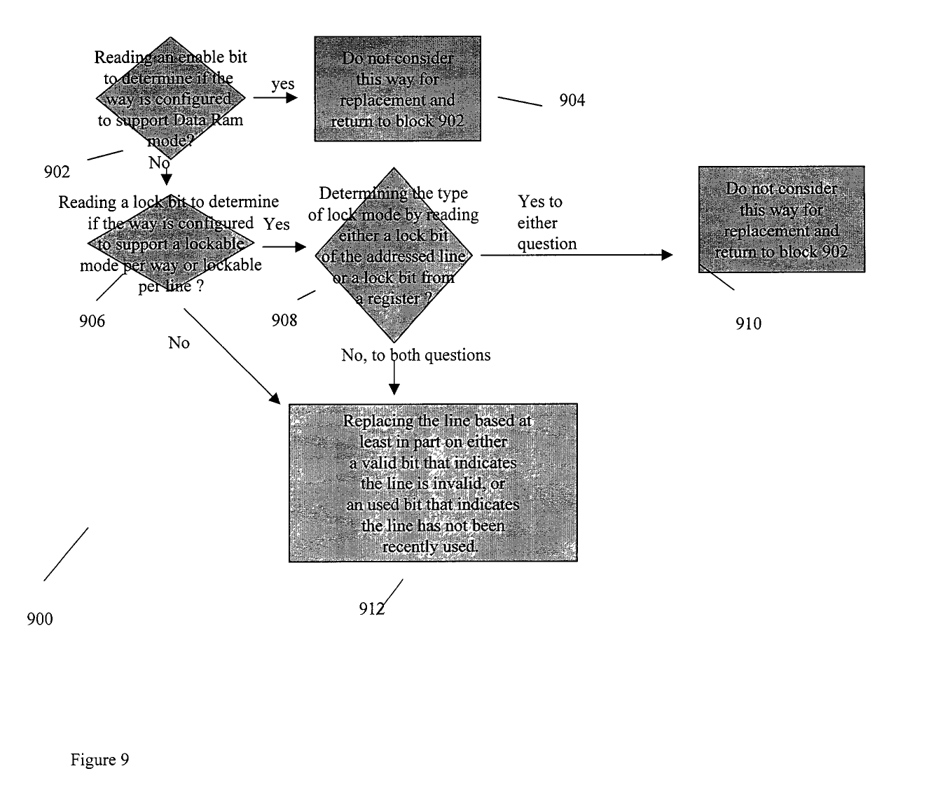

FIG. 2 is a schematic diagram of a cache utilized by an embodiment. In essence, a cache is two-dimensional and may be defined by a plurality of n ways 202 and m sets 204. FIG. 2 depicts an n-way set associative cache. In one embodiment, the cache is a tag cache with eight ways and 2048 sets. Also, the cache has a plurality of lines 206 that are addressed by their respective way and set. In the same embodiment, each line comprises, but is not limited to, a valid bit, used bit, lock bit, and a Tag address field. The depicted cache supports the lock per line mode and facilitates the replacement method depicted in connection with FIGS. 1 and 9.

The cache depicted in FIG. 2 is not limited to an eight-way cache with 2048 sets. For example, the cache may support a plurality of different ways and sets, such as, a four way set associative cache.

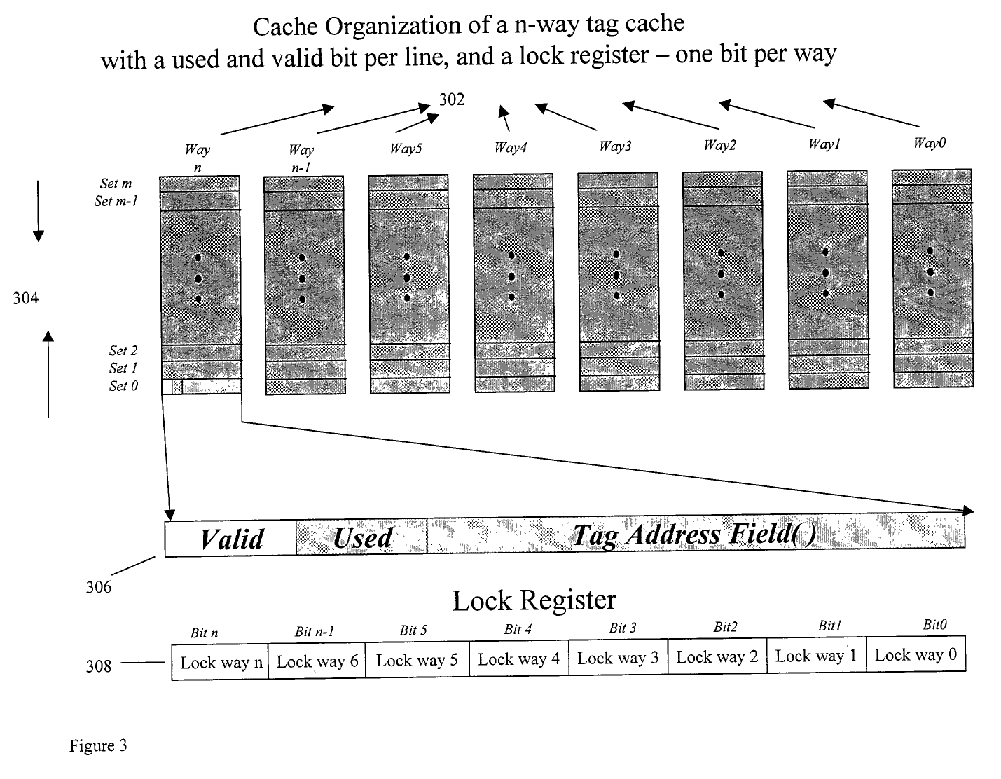

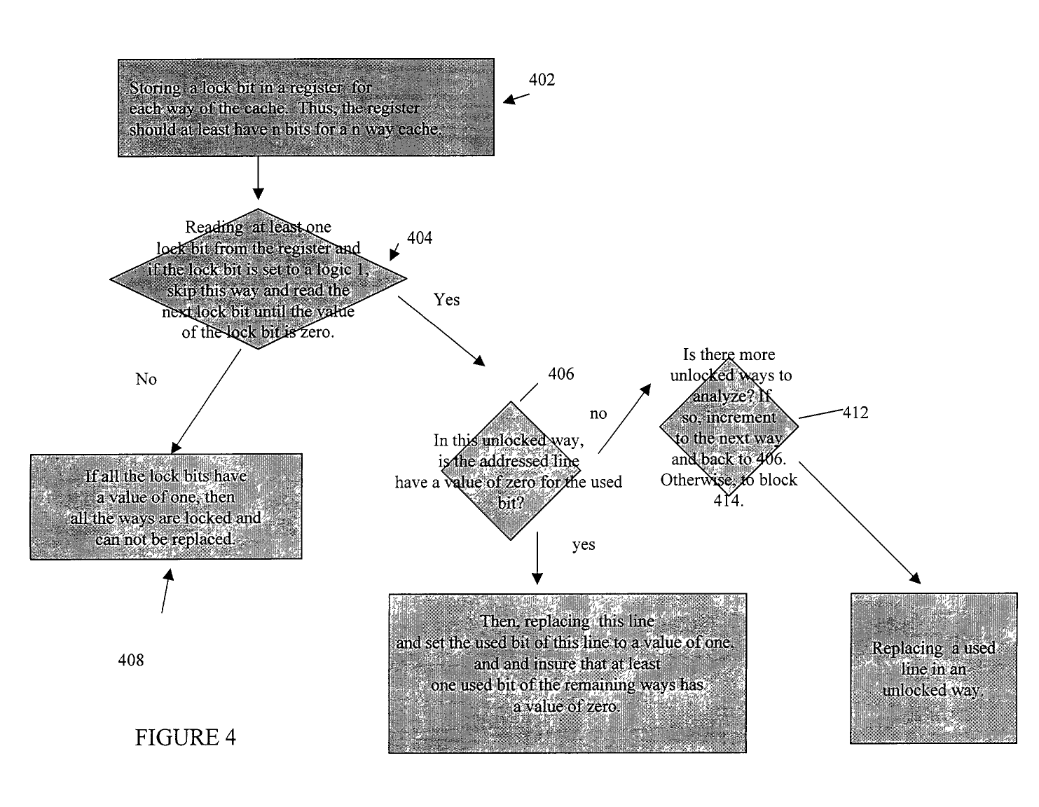

FIG. 3 is a schematic diagram of a cache utilized by an embodiment. In essence, a cache is two-dimensional and may be defined by a plurality of n ways and m sets. FIG. 3 depicts an n-way set associative cache. In one embodiment, the cache is a tag cache with eight ways and 2048 sets. Also, the cache has a plurality of lines that are addressed by their respective way and set. In the same embodiment, each line comprises, but is not limited to, a valid bit, used bit, and a Tag address field. Likewise, there is a register to store a plurality of lock bits. In one embodiment, a single lock bit is stored for each way. Alternatively, in another embodiment, one lock bit is stored for each line in the way and facilitates the locking of the entire way by setting all the lock bits to the same value. The depicted cache supports the lock per way mode and facilitates the replacement method depicted in connection with FIGS. 4 and 9.

The cache depicted in FIG. 3 is not limited to an eight-way cache with 2048 sets. For example, the cache may support a plurality of different ways and sets, such as, a four way set associative cache with 1024 sets.

FIG. 4 is a method utilized by an embodiment. The method includes, but is not limited to, the following blocks 402, 404, 406, 408, 410, and 412. In one embodiment, the method supports a replacement scheme for a cache with at least one way to support a lock per way mode. In one example, the cache memory supports multiple configurations. For example, a four way cache with a first way to support a lock per line mode. In contrast, a second way supports a lock per way mode, the third way supports a Data Ram mode, and the fourth way does not support either a lock mode or Data Ram mode. Alternatively, three of the four ways may support lock per way mode, while the remaining way supports the Data Ram mode. The previous examples illustrate just a few permutations. One skilled in the art appreciates the ability of the claimed subject matter to support multiple permutations of the cache configurations and the resulting replacement scheme.

The block 402 stores a lock bit in a register for each way of the cache. Thus, the register should at least have n bits for a n-way cache. Each lock bit represents whether the way is locked to prevent replacement. In one embodiment, a value of one for the lock bit indicates the way is locked to prevent replacement. The next block 404 reads the lock bits in the register to determine if any of the ways are not locked. In the same embodiment, the value of one indicates the way is locked, while a value of zero indicates the way is not locked. The flow ends at block 408 when all the lock bits are set to logic 1 that indicates the ways are locked and cannot be replaced. Otherwise, if at least one way has a value of zero for the respective lock bit, then the flowchart continues with block 406.

Block 406 reads the used bits of the lines for the way that has a value of zero for the lock bit, which indicates the way is not locked and is a candidate for replacement. If the line has a value of zero for the used bit, this indicates the line has not been recently used and the flow proceeds to block 410 which replaces this line with the pending new information and sets to the used bit to a logic one. Likewise, the block insures that at least one used bit of the remaining ways has a value of zero.

Otherwise, when block 406 cannot find a line in the unlocked way with a value of zero for the used bit, the flowchart proceeds to block 412 where the flowchart replaces a used line in an unlocked way.

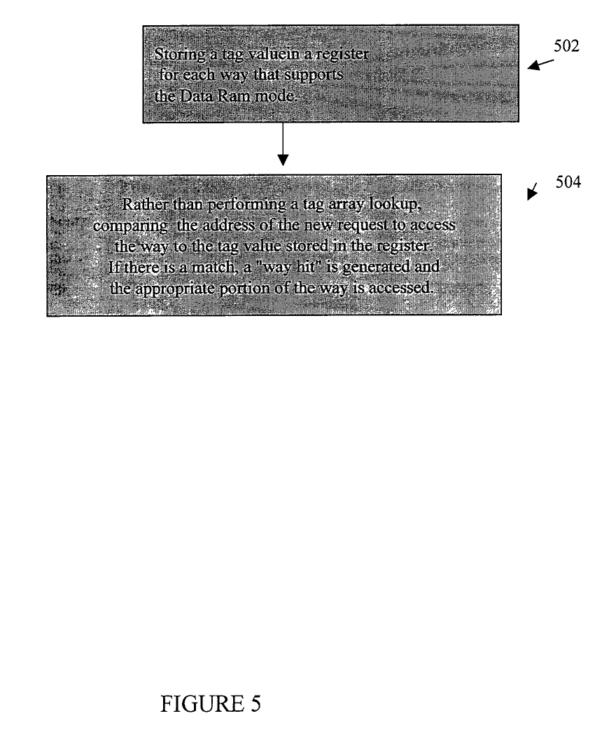

FIG. 5 is a method utilized by an embodiment. In one embodiment, the method is an access scheme to a cache that has at least one way to support a Data Ram mode. The method includes, but is not limited to, the following blocks 502 and 504. A tag value is stored in a register for each way in the cache that supports the Data Ram mode,. For example, in one embodiment for a four-way cache, three ways may support the Data Ram mode and each way will have a register for storing a respective tag value. Alternatively, in another embodiment, only one way supports the Data Ram mode and this single way will have a register to store a tag value.

Subsequently, when the cache receives an access request, the tag value of the access request is compared to the tag value stored in the register of each way that supports Data Ram mode. If the tag value of the access request matches one of the tag values stored in the register(s) of the way(s) that support Data Ram mode, then a “way hit” is generated and the a portion of the way is accessed based at least in part on the address of the access request.

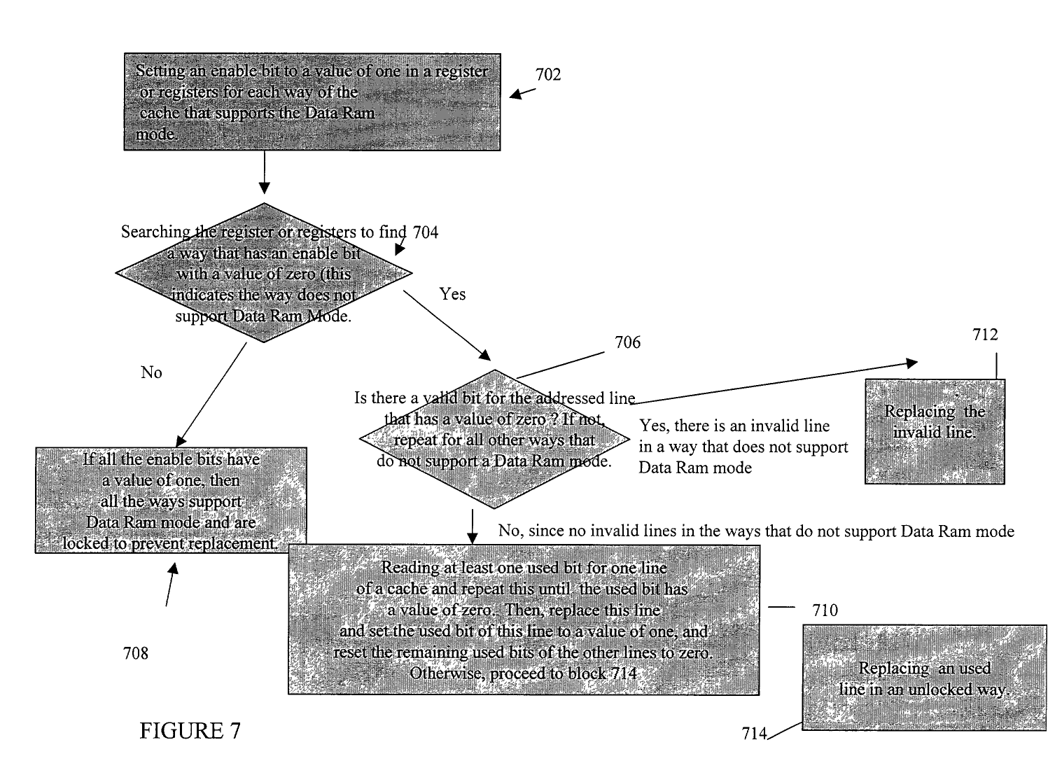

The schematic diagram in FIG. 5 facilitates the replacement schemes depicted in connection with FIGS. 7 and 9.

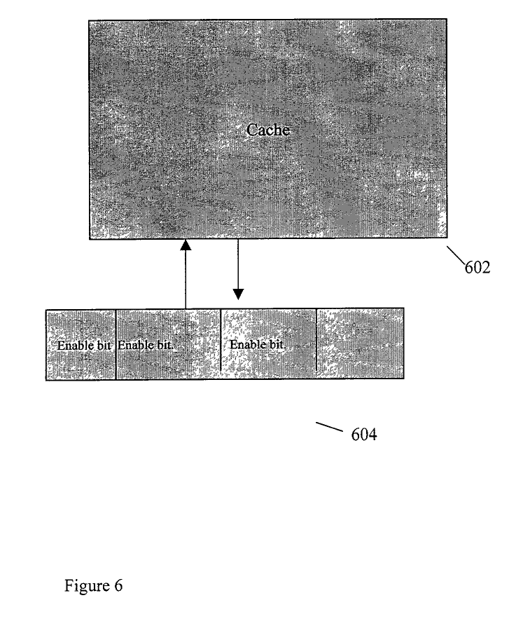

FIG. 6 is a schematic diagram of a cache utilized by an embodiment. In one embodiment, the cache 602 is a n way set associative cache coupled to a register 604 that stores an enable bit for each way of the cache. In one embodiment, the enable bit is set to a logic one value to indicate the respective way supports the Data Ram mode. In contrast, the enable bit is set to a logic zero to indicate the respective way does not support the Data Ram mode. Therefore, each enable bit indicates whether the respective way supports the Data Ram mode.

The cache in FIG. 6 facilitates the replacement scheme depicted in connection with FIGS. 7 and 9.

FIG. 7 is a method utilized by an embodiment. The method includes, but is not limited to, the following blocks 702, 704, 706, 708, 710, 712, 714. In one embodiment, the method supports a replacement scheme for a cache that has a plurality of ways. In the same embodiment, the replacement scheme does not consider any ways that support a Data Ram mode since they are essentially locked to prevent replacement.

In one embodiment, the cache memory has a plurality of ways to support multiple configurations. For example in a four-way cache, a first way supports a lock per line mode, a second way supports a lock per way mode, a third way supports a Data Ram mode, and the remaining way does not support a lock mode or Data Ram. Alternatively, three of the four ways may support lock per way mode, while the remaining way supports the Data Ram mode. In yet another embodiment, all the ways support either a lock per line mode or a lock per way mode and do not support the Data Ram mode. The previous examples illustrate just a few permutations. One skilled in the art appreciates the ability of the claimed subject matter to support multiple permutations of the cache configurations and the resulting replacement scheme.

The block 702 sets an enable bit to a logic one in a register for each way of the cache that supports the Data Ram mode. Subsequently, the next block 704 searches the enable bit of the register(s) to locate an enable bit that has a value of logic 0, thus, indicating the respective way does not support the Data Ram mode and allows replacements of lines in the way. Otherwise, if all the enable bits have a value of logic one, then proceed to block 708 that terminates the flowchart because the Data Ram mode is enabled on all ways, thus, preventing lines from being replaced.

If block 704 finds an enable bit with a value of zero, the method proceeds to block 706. Block 706 checks if valid bit of addressed line of the way has a value of zero. If so, the line is invalid and is replaced with the pending new request in a block 712.

Otherwise, block 706 repeats checking the valid bits for the remaining ways that do not support Data Ram mode. Despite searching the remaining ways, the method proceeds to block 710. in the absence of an invalid line in the ways that do not support Data Ram mode.

Block 710 searches for a line of the way that has a used bit with a value of zero. If so, the line has not been recently accessed and is replaced with the pending new request. Also, the used bit of this line is set to a logic one, and the block insures that at least one used bit of the remaining ways has a value of zero. Otherwise, the flowchart proceeds to block 714, which replaces a used line in an unlocked way.

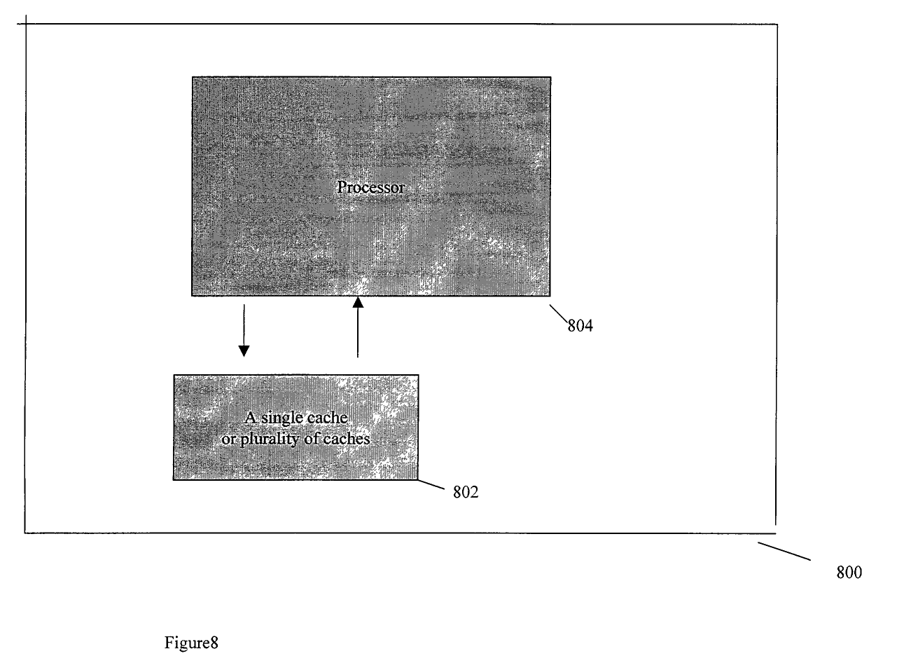

FIG. 8 illustrates a system in accordance with one embodiment. The system 800 may be a computing system, computer, personal digital assistant, or integrated device. The system comprises a processor 804 and at least one cache 802. The processor 804 executes instructions and requests information from the cache 802. In one embodiment, the cache is integrated within the processor. Alternatively, in another embodiment the cache is external to the processor.

In one embodiment, the cache 802 has a plurality of ways, with at least one way to support either one of the following configurations: lock per line mode, lock per way mode, or Data Ram mode. In another embodiment, a plurality of caches 802 is utilized and at least one cache has at least one way to support either one of the following configurations: lock per line mode, lock per way mode, or Data Ram mode. Likewise, at least one cache 802 may support two or three of the previously described configurations.

The cache or caches 802 support(s) the replacement scheme depicted in connection with FIG. 5. Also, the cache(s) 802 may have at least one way to support any combination of the cache architectures depicted in connection with FIGS. 1, 2, and 3.

However, the claimed subject matter is not limited to the three previously described configurations. For example, the cache architectures depicted in connection with FIGS. 2, 3, and 6 may support more than the three configurations with additional control logic and control bits.

FIG. 9 is a method in accordance with one embodiment. The method includes, but is not limited to, the following blocks 902, 904, 906, 908, 910, and 912. In one embodiment, the method performs a replacement scheme for a cache that has a plurality of ways, with at least one way supporting either a Data Ram mode, lock per way mode, or lock per line mode. In another embodiment, the cache has multiple ways that support Data Ram mode, lock per way mode, or lock per line mode. For example, in a four-way cache, a first way supports Data Ram mode, and the remaining three ways do not support Data Ram mode, lock per way mode, or lock per line mode. In contrast, in another embodiment for a four-way cache, a first way supports Data Ram mode, a second way supports lock per way mode, and the remaining two ways do not support Data Ram mode, lock per way mode, or lock per line mode. The preceding examples illustrate only a few permutations. For example, the cache may have a different number of ways and/or different combinations of configurable modes.

In one embodiment, the method supports a cache with a plurality of ways. In one embodiment, at least one way is configured to support either a lock mode or Data Ram mode. If the way supports a lock mode, it comprises a valid bit, used bit, and lock bit for each line or per way. In the same embodiment, the used bit conforms to a Not Recently Used (NRU) replacement protocol. As previously discussed, the valid bit and lock bit determine whether the line is invalid and whether the line is locked, respectively.

The method depicts a flow for selecting a line in a way for replacement. The method starts with block 902 by determining whether a selected way supports Data Ram mode by reading the way's respective enable bit. A way supports Data Ram mode when the enable bit has a value of logic one, thus, the way will not be considered for replacement, which is indicated by block 904. Also, the flow repeats by starting at block 902 for a different way. Alternatively, in another embodiment the claimed subject matter allows for a parallel analysis of all the ways rather than the sequential manner depicted in this flowchart. For example, the parallel analysis begins with a substantially simultaneous analysis of both blocks 902 and 906 and continues based on the results of both blocks.

The method ends at block 902 if all the enable bits are set to logic one. Otherwise, the proceeds to block 906 to determine if the way supports a lock per way or lock per line mode. In one embodiment, the lock modes are determined by a lock bit stored in a register for a lock per way mode or by a lock bit stored for each line for a lock per line mode. If the way does support either lock mode, the method proceeds to block 908 that analyzes if the way is locked or if all the lines are locked in the way based at least in part on the lock bit value. Otherwise, the method proceeds to block 912 that is discussed in the next paragraph. For a way that supports the lock per line mode, the lock bit for all the lines is set to a logic one if all the lines are locked. For a way that supports lock per way mode, the lock bit for the way is set to a logic one when the way is locked. If either the way is locked for all lines or the way is locked, the flow proceeds to block 910 to indicate the way is not considered for replacement. Also, the flow repeats by starting at block 902 for a different way.

If either the way is not locked for the lock per way mode or all the lines are not locked for the lock per line mode, the flow proceeds to block 912 to analyze the used bit and/or the valid bit of the lines for the respective way. The block replaces a line based at least in part on either a line that is invalid or a line that has not been recently used. In one embodiment, an invalid line has a valid bit with a value of zero. In one embodiment, a not recently used line has a used bit with a value of zero. Thus, the method facilitates the cache maintaining the same replacement scheme despite the multiple configurations of the ways to support lockable modes or data Ram mode, or both.

The specification depicted a sequential manner for analyzing the plurality of ways in the flowcharts depicted in FIGS. 1, 4, 5, 7, and 9. The sequential manner is one embodiment and is illustrated to clearly explain the replacement schemes to the reader. In contrast, in another embodiment the plurality of ways in the flowcharts depicted in FIGS. 1, 4, 5, 7, and 9 are analyzed in a parallel manner. For example, all the ways are analyzed in a substantially simultaneous manner.

The claimed subject matter allows for the cache to have multiple configurations and to allow for the same NRU replacement scheme to be utilized for all the methods depicted in FIGS. 1, 4, 5, 7, and 9.

While certain features of the claimed subject matter have been illustrated and detailed herein, many modifications, substitutions, changes and equivalents will now occur to those skilled in the art. It is, therefore, to be understood that the appended claims are intended to cover all such modifications and changes as fall within the true spirit of the claimed subject matter.

1. A method for replacing a line in a cache memory with a plurality of ways, each way with a plurality of lines, comprising:
reading at least one lock bit;
configuring at least one way of the plurality of ways for supporting either one of a Data Ram mode or a lock mode; and
selecting the line in the cache memory for replacement based at least in part on the mode and the lock bit.

2. The method of claim 1 wherein the lock mode is either a lock per line mode or a lock per way mode.

3. The method of claim 1 wherein the lock bit is stored in the line for the lock per line mode or the lock bit is stored in a register for the lock per way mode.

4. The method of claim 1 wherein each line of the way that supports either lock mode has a valid bit and a used bit.

5. The method of claim 4 wherein selecting the line for replacement is based at least in part on the modes that are supported by the plurality of ways and comprises:
reading the valid bit and lock bit from the line if the way supports a lock per line mode;
reading the used bit from the line and lock bit from the register if the way supports a lock per way mode; and
reading an enable bit from a register and the used bit and valid bit from the line, if the way supports the Data Ram mode.

6. The method of claim 5 wherein selecting the line for replacement comprises:
replacing the line if the line is unlocked and either invalid or not been recently used, if the way supports a lock per line mode;
replacing the line if the line has not been recently used and the way is not locked if the way supports a lock per way mode; and
replacing the line if the line is invalid or if the line has not been recently used if the way has not been enabled to support Data Ram mode.

7. The method of claim 1 wherein the cache is a L0, L1, or L2 cache.

8. The method of claim I wherein the plurality of ways is eight.

9. An apparatus comprising:
a cache with a plurality of ways, each way with a plurality of lines;
a lock bit;
an enable bit to determine whether the way supports a Data Ram mode; and
at least one of the plurality of ways to support either the Data Ram mode or a lock mode and the cache to utilize a Not Recently Used (NRU) replacement protocol based at least in part on the lock bit and the enable bit.

10. The apparatus of claim 9 wherein the lock mode is either a lock per line mode or a lock per way mode.

11. The apparatus of claim 9 wherein the lock bit is stored in the line for the lock per line mode or the lock bit is stored in a register for the lock per way mode.

12. The apparatus of claim 9 wherein the NRU replacement protocol selects the line for replacement based at least in part on the modes that are supported by the plurality of ways and comprises:
NRU replacement protocol to read the lock bit, valid bit, and the used bit if the valid bit indicates the line is valid, when the way supports a lock per line mode;
NRU replacement protocol to read the used bit if the way supports a lock per way mode; and
NRU replacement protocol to read an enable bit and the used bit when the way is not enabled for the Data Ram mode.

13. The apparatus of claim 12 wherein the NRU replacement protocol comprises:
to replace the line if the line is unlocked and either invalid or not been recently used if the way supports a lock per line mode;
to replace the line if the line has not been recently used and the way is not locked if the way supports a lock per way mode and
to replace the line if the line is invalid or if the line has not been recently used for a way that does not have the Data Ram mode enabled

14. A system comprising:
a processor;
a cache, coupled to the processor, with a plurality of ways, each of the plurality of ways with a plurality of lines;
at least one of the plurality of ways to support either a Data Ram mode or lock mode and the cache to utilize a Not Recently Used (NRU) replacement protocol based at least in part on the mode and a lock bit.

15. The system of claim 14 wherein the lock mode is either a lock per line mode or a lock per way mode.

16. The system of claim 14 wherein the lock bit is stored in the line for the lock per line mode or the lock bit is stored in a register for the lock per way mode.

17. The system of claim 14 wherein the NRU replacement protocol selects the line for replacement based at least in part on the modes that are supported by the plurality of ways and comprises:
NRU replacement protocol to read the lock bit, valid bit, and the used bit if the valid bit indicates the line is valid, when the way supports a lock per line mode;
NRU replacement protocol to read the used bit if the way supports a lock per way mode; and
NRU replacement protocol to read an enable bit and the used bit when the way is not enabled for the Data Ram mode.

18. The system of claim 14 wherein the NRU replacement protocol comprises:
to replace the line if the line is unlocked and either invalid or not been recently used if the way supports a lock per line mode;
to replace the line if the line has not been recently used and the way is not locked if the way supports a lock per way mode and
to replace the line if the line is invalid or if the line has not been recently used for a way that does not have the Data Ram mode enabled

19. A cache memory comprises:
a plurality of ways and sets, each way with a plurality of lines;
at least one configurable way to support either one of a Data Ram mode or a lock mode;
an enable bit for each one of the plurality of ways to determine whether the way supports the Data Ram mode; and
the cache utilizes a Not Recently Used (NRU) replacement protocol to replace a line based at least in part on the mode and the enable bit.

20. The cache of claim 19 wherein the lock mode is either a lock per line mode or a lock per way mode.

22. The cache of claim 19 wherein the NRU replacement protocol selects the line for replacement based at least in part on the modes that are supported by the plurality of ways and comprises:
NRU replacement protocol to read the lock bit, valid bit, and the used bit if the valid bit indicates the line is valid, when the way supports a lock per line mode;
NRU replacement protocol to read the used bit if the way supports a lock per way mode; and
NRU replacement protocol to read an enable bit and the used bit when the way is not enabled for the Data Ram mode.

23. The cache of claim 22 wherein the NRU replacement protocol comprises:
to replace the line if the line is unlocked and either invalid or not been recently used if the way supports a lock per line mode;
to replace the line if the line has not been recently used and the way is not locked if the way supports a lock per way mode and
to replace the line if the line is invalid or if the line has not been recently used for a way that does not have the Data Ram mode enabled

24. A cache memory comprises:
a plurality of ways;
a plurality of sets;
at least one configurable way to support a lock mode and at least another configurable way to support a Data Ram mode; and
a Not Recently Used (NRU) replacement protocol to support the configurable ways for both the lock mode and Data Ram mode.

25. The cache memory of claim 24 wherein the lock mode is either a lock per line mode or a lock per way mode.

26. The cache of claim 24 wherein the NRU replacement protocol selects the line for replacement based at least in part on the modes that are supported by the plurality of ways and comprises:
NRU replacement protocol to read the lock bit, valid bit, and the used bit if the valid bit indicates the line is valid, when the way supports a lock per line mode;
NRU replacement protocol to read the used bit if the way supports a lock per way mode; and
NRU replacement protocol to read an enable bit and the used bit when the way is not enabled for the Data Ram mode.

27. The cache of claim 26 wherein the NRU replacement protocol comprises:
to replace the line if the line is unlocked and either invalid or not been recently used if the way supports a lock per line mode;
to replace the line if the line has not been recently used and the way is not locked if the way supports a lock per way mode and
to replace the line if the line is invalid or if the line has not been recently used for a way that does not have the Data Ram mode enabled

28. The cache memory of claim 24 wherein the plurality of ways is eight and the plurality of sets is 2048.

29. A processor comprises:
a cache, with a plurality of ways and sets and at least one way to be configurable to support either a Data Ram mode or a lock mode;
the cache to utilize a Not Recently Used (NRU) replacement protocol to support the replacement of a line for the plurality of ways, despite if one of the configurable ways is configured to support either the Data Ram mode or the lock mode.

30. The processor of claim 29 wherein the lock mode is either a lock per line mode or a lock per way mode.

31. The processor of claim 29 wherein the NRU replacement protocol selects the line for replacement based at least in part on the modes that are supported by the plurality of ways and comprises:
NRU replacement protocol to read a lock bit, a valid bit, and a used bit if the valid bit indicates the line is valid, when the way supports a lock per line mode;
NRU replacement protocol to read a used bit if the way supports a lock per way mode; and
NRU replacement protocol to read an enable bit and a used bit when the way is not enabled for the Data Ram mode.

32. The processor claim 31 wherein the NRU replacement protocol comprises:
to replace the line if the line is unlocked and either invalid or not been recently used if the way supports a lock per line mode;
to replace the line if the line has not been recently used and the way is not locked if the way supports a lock per way mode and
to replace the line if the line is invalid or if the line has not been recently used for a way that does not have the Data Ram mode enabled
